(19) United States
(12) Patent Application Publication
(10) Pub. No.: US 2012/0062859 A1
(43) Pub. Date: Mar. 15, 2012

(54) POLISHING DEVICE, POLISHING METHOD, EXPOSURE APPARATUS AND DEVICE MANUFACTURING METHOD

(75) Inventor: YASUHIRO KITAMURA, Fukaya-shi (JP)

(73) Assignee: NIKON CORPORATION

(21) Appl. No.: 13/225,061

(22) Filed: Sep. 2, 2011

Related U.S. Application Data
(63) Continuation of application No. PCT/JP2010/057813, filed on May 7, 2010.
(60) Provisional application No. 61/213,676, filed on Jul. 1, 2009.

(51) Int. Cl. G03B 27/52

(52) U.S. Cl. 355/30; 355/77

(57) ABSTRACT

An exposure apparatus includes a projection optical system and a liquid supply device. The projection optical system includes an image plane side optical member, which is arranged in an optical path of exposure light, and a lens barrel, which supports the image plane side optical member. The liquid supply device polishes the image plane side optical member in a state supported by the lens barrel to change the shape of the image plane side optical member.

### CROSS-REFERENCE TO RELATED APPLICATIONS

This application is a continuation application of International Application No. PCT/JP2010/057813, filed on May 7, 2010, which is based upon and claims the benefit of priority from the prior U.S. Patent Application No. 61/213,676, filed on Jul. 1, 2009, the entire contents of which are incorporated herein by reference.

### BACKGROUND OF THE INVENTION

The present invention relates to an exposure apparatus including an optical member such as a lens and a method for manufacturing a device with the exposure apparatus. Further, the present invention relates to a polishing device and polishing method that polishes an optical member such as a lens.

Generally, in a lithography process for manufacturing a micro-device such as a semiconductor integrated circuit, an exposure apparatus is used to form a pattern (circuit pattern or the like) on a substrate, such as a wafer or glass plate, to which a photosensitive material is applied. A projection optical system mounted in such exposure apparatus includes a lens barrel and a plurality of optical members (lenses etc.) accommodated in the lens barrel. The optical members are each supported in the lens barrel by an optical member holding device that allows movement of the optical member relative to the lens barrel.

In the exposure apparatus, aberration (also referred to as wave-front aberration) of the projection optical system is adjusted by driving the optical member holding devices to adjust the position of each optical member. By performing an exposure process in a state in which the aberration of the projection optical system is appropriately adjusted in this manner, a pattern having an appropriate size and shape is formed on the substrate, which is located at an image field (image plane) side of the projection optical system.

Further, some of the photosensitive material applied to the substrate may vaporize, and the vaporized photosensitive material may collect on the surface of an optical member. U.S. Pat. No. 6,496,257 and US Patent Application Publication No. 2005/0274898 disclose techniques for removing foreign matter such as a smear formed on an optical member.

When the exposure apparatus is used over a long period, the aberration of the projection optical system may change over time. Generally, the aberration of the projection optical system is thus adjusted in regular or irregular intervals. However, the only way to adjust the aberration of the projection optical system in the conventional exposure apparatus is to move the optical members. This limits the adjustment of the aberration of the projection optical system.

To solve this problem, Japanese Laid-Open Patent Publication No. 2006-245085 describes a method that arranges a structure in a projection optical system to remove some of the optical members from a lens barrel, polish the optical members removed from the lens barrel, and re-arranges the polished optical members in the lens barrel. However, in this method, the optical members are required to be removed from and returned to the lens barrel. This is troublesome.

The present invention provides a polishing device, a polishing method, an exposure apparatus, and a device manufacturing method that easily adjusts the aberration of the optical system.

### SUMMARY OF THE INVENTION

A first aspect of the present invention is an exposure apparatus that illuminates a predetermined pattern with light and irradiates a substrate, to which a photosensitive material is applied, with the light that passes through the predetermined pattern. The exposure apparatus is provided with an optical system including an optical member, which is arranged in an optical path of the light, and a support member, which supports the optical member. A polishing device polishes the optical member in a state supported by the support member to change shape of the optical member.

A second aspect of the present invention is a method for manufacturing a device. The method includes exposing a pattern image, with the exposure apparatus of the first aspect, based on the predetermined pattern on a surface of the substrate. The method further includes developing the exposed substrate to form a mask layer having a shape corresponding to the pattern image on the surface of the substrate, and processing the surface of the substrate through the mask layer formed on the surface of the substrate.

A third aspect of the present invention is a polishing device arranged on an exposure apparatus that illuminates a predetermined pattern with light and irradiates a substrate, to which a photosensitive material is applied, with the light that passes through the predetermined pattern. The exposure apparatus is provided with an optical system including an optical member, which is arranged in an optical path of the light, and a support member, which supports the optical member, and wherein the polishing device polishes the optical member in a state supported by the support member to change shape of the optical member.

A fourth aspect of the present invention is an exposure apparatus including the polishing device of the third aspect.

A fifth aspect of the present invention is a method for manufacturing a device. The method includes exposing a pattern image, with the exposure apparatus of the fourth aspect, based on the predetermined pattern on a surface of the substrate. The method further includes developing the exposed substrate to form a mask layer having a shape corresponding to the pattern image on the surface of the substrate, and processing the surface of the substrate through the mask layer formed on the surface of the substrate.

A sixth aspect of the present invention is a method for polishing an optical member of an exposure apparatus. The exposure apparatus illuminates a predetermined pattern with light and irradiates a substrate, to which a photosensitive material is applied, with the light passing through the predetermined pattern. The exposure apparatus is provided with an optical system including the optical member, which is arranged in an optical path of the light, and a support member, which supports the optical member. The method includes polishing the optical member in a state supported by the support member to change shape of the optical member.

A seventh aspect of the present invention is a method for manufacturing a device using an exposure apparatus that illuminates a predetermined pattern with light and irradiates a substrate, to which a photosensitive material is applied, with the light that passes through the predetermined pattern. The exposure apparatus is provided with an optical system including an optical member, which is arranged in an optical path of the light, and a support member, which supports the optical member. The method includes exposing a pattern image based on the predetermined pattern on a surface of the substrate, developing the exposed substrate to form a mask layer having a shape corresponding to the pattern image on the surface of the substrate, processing the surface of the substrate through the mask layer formed on the surface of the substrate, and polishing the optical member in a state supported by the support member to change shape of the optical member using the method of the sixth aspect at a time that differs from a time when the surface of the substrate is exposed.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing one embodiment of an exposure apparatus;

FIG. 2 is a schematic cross-sectional view showing a main part of the exposure apparatus;

FIGS. 3(a) and 3(b) are schematic views Showing the polishing of a peripheral portion in an exit surface of an image plane side optical member;

FIGS. 4(a) and 4(b) are schematic diagrams showing a liquid supply device in another embodiment;

FIG. 5 is a schematic diagram showing a wafer stage in a further embodiment;

FIG. 6 is a schematic diagram showing a polishing device in a further embodiment;

FIG. 7 is a schematic diagram showing a polishing device of another embodiment mounted on the wafer stage;

FIG. 8 is a schematic diagram showing a polishing device in a further embodiment arranged on a measurement stage;

FIG. 9 is a flowchart of an example for manufacturing a device; and

FIG. 10 is a detailed flowchart related to substrate processing for a semiconductor device.

### DETAILED DESCRIPTION OF THE INVENTION

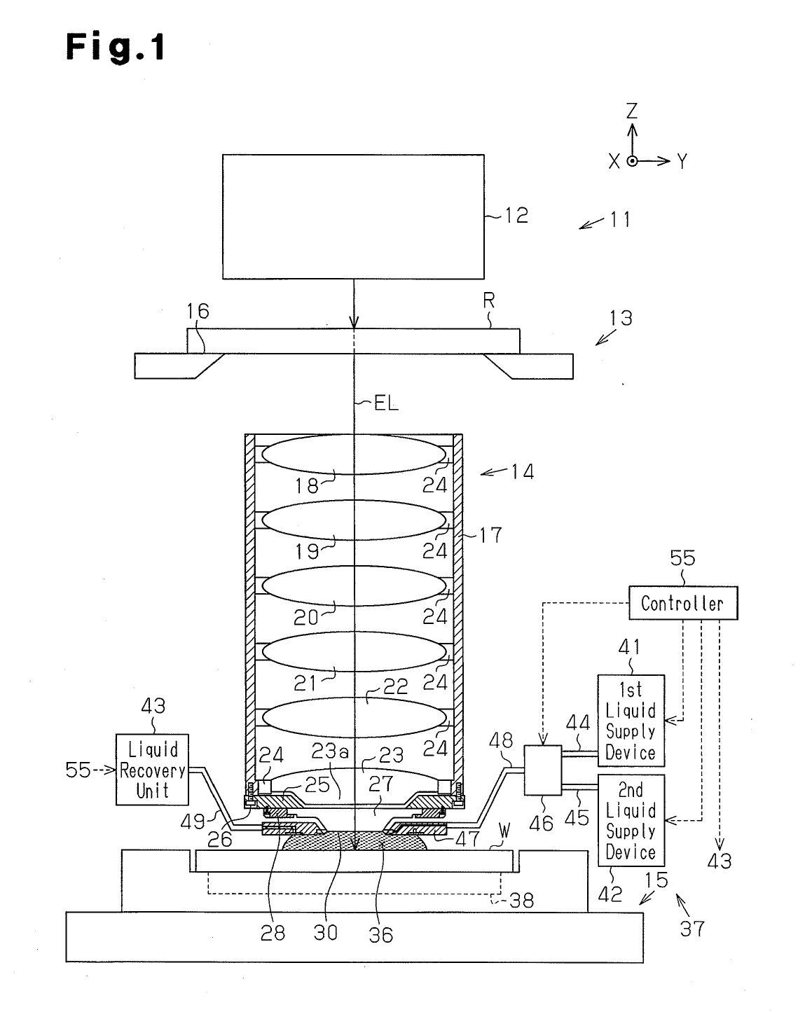

One embodiment will now be described with reference to FIGS. 1 to 3. In the description hereafter, a direction parallel to an optical axis of a projection optical system is referred to as a Z axis direction, a direction in which a reticle R and a wafer W are scanned during scanning exposure in a plane perpendicular to the Z axis direction is referred to as a Y axis direction, and a non-scanning direction perpendicular to the scanning direction is referred to as an X axis direction. Further, rotation directions around the X axis, Y axis, and the Z axis are respectively referred to as a θx direction, a θy direction, and a θz direction.

As shown in FIG. 1, in the present embodiment, an exposure apparatus 11 uses exposure light EL emitted from a light source device (not shown) to the reticle R, which serves as a mask on which a predetermined circuit pattern is formed, and projects an image of the circuit pattern onto the wafer W to which a photosensitive material such as a resist is applied. The exposure apparatus 11 includes an illumination optical system 12, which illuminates the reticle R with the exposure light EL from the light source device, a reticle stage 13, which supports the reticle R, a projection optical system 14, which irradiates the wafer W with the exposure light EL through the reticle R, and a wafer stage 15, which holds the wafer W. The light source device in the present embodiment is a light source that emits ArF excimer laser light (wavelength, 193 nm) as the exposure light EL.

The illumination optical system 12 includes an optical integrator such as a fly's eye lens or a rod lens (not shown), a variety of lens systems such as relay lenses and condenser lenses, and an aperture stop (not shown). The exposure light EL emitted from the light source device (not shown) passes through the illumination optical system 12 and forms a tetragonal illumination region on the reticle R. The illumination region has a uniform light intensity distribution (luminance distribution) and extends in the X axis direction (direction perpendicular to the plane of FIG. 1).

The reticle stage 13 is arranged between the illumination optical system 12 and the projection optical system 14 so that a mount surface 16 for the reticle R is generally orthogonal to an optical path. That is, the reticle stage 13 is arranged on an object surface side of the projection optical system 14 (+Z direction side, upper side as viewed in FIG. 1). Further, the reticle stage 13 is includes a holding unit (not shown), which holds the reticle R, such as a vacuum chuck (not shown) that vacuum-attracts the reticle R. A reticle stage drive unit (not shown) drives and moves the reticle stage 13 in the Y axis direction (right-and-left direction in FIG. 1). That is, the reticle stage drive unit moves the reticle R, which is held on the holding unit, in the Y axis direction with a predetermined stroke. Further, the reticle stage drive unit is also capable of moving the reticle R in the X axis direction and the θz direction.

The projection optical system 14 reduces an image of a circuit pattern, which is formed by illuminating the reticle R with the exposure light EL, by a predetermined reduction rate (for example, 1/4x) and includes a substantially cylindrical lens barrel 17. The lens barrel 17 is filled with purge gas such as nitrogen gas. In the lens barrel 17, a plurality of (only six shown in FIG. 1) optical members (lenses in the present embodiment) 18, 19, 20, 21, 22, and 23 are arranged in the Z axis direction (vertical direction in FIG. 1). The optical members 18 to 23 are each supported by a holding device 24 in the lens barrel 17. Each holding devices 24 enables movement of the corresponding one of the optical members 18 to 23 in a plurality of directions. The holding devices 24 are described in, for example, U.S. Pat. No. 6,930,842 and US Patent Application Publication No. 2007/0183064.

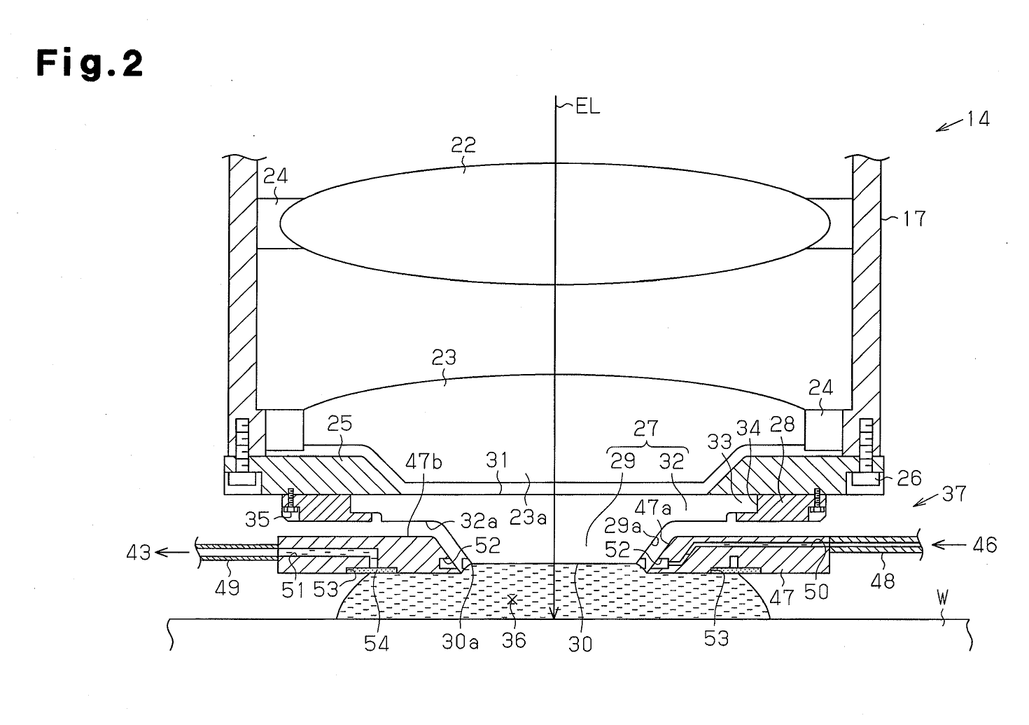

As shown in FIGS. 1 and 2, an annular fixation member 25, which surrounds an emission portion 23a of the optical member 23, is fixed by a plurality of first bolts 26 (only two shown in FIG. 2) to an end of the lens barrel 17 at the −Z axis direction side (lower end in FIG. 1). That is, the fixation member 25 is formed to surround an optical path of the exposure light EL emitted from the optical member 23. Further, an image plane side optical member 27 (also referred to as “objective lens”) is arranged on the −Z direction side of the fixation member 25 located toward the image plane side (−Z direction side, lower side as viewed in FIG. 1) from the optical members 18 to 23 in the lens barrel 17. The image plane side optical member 27 is supported by an annular lens holder 28 and the fixation member 25 on the lens barrel 17.

Specifically, as shown in FIG. 2, the image plane side optical member 27 is circular when viewed from the Z axis direction and includes a central portion through which an exposure light passage 29 extends. The exposure light EL passes through the exposure light passage 29. The exposure light passage 29 includes an exit surface 30 (−Z direction side) and a parallel entrance surface 31 (+Z direction side face). Further, the image plane side optical member 27 includes an annular flange 32 extending from the periphery of the exposure light passage 29. A peripheral portion of the flange 32 includes a plurality of tabs 33 (only two of which are shown in FIG. 2) extending outward in a radial direction about an optical axis (not shown) of the projection optical system 14. The tabs 33 are arranged at equal intervals in the circumferential direction. When the difference in refractive index is small between the image plane side optical member 27 and a first liquid, which will be described later, a reflection prevention coating does not have to be applied to the exit surface 30 of the image plane side optical member 27.

Further, the lens holder 28 is formed so that its inner side is located at the same radial position as the tabs 33 of the image plane side optical member 27. The lens holder 28 includes recesses 34, which receive the tabs 33. In a state in which the tabs 33 are received in the corresponding recesses 34, the lens holder 28 is fastened by a plurality of second bolts 35 (only two shown in FIG. 2) to the fixation member 25. This supports the image plane side optical member 27 in an immovable state. Here, a +Z direction side of each tab 33 is arranged in contact with the fixation member 25, and the two opposite surfaces each tab 33 in the circumferential direction are both arranged in contact with the side walls of the corresponding recess 34.

In the present embodiment, a predetermined void 36 between the image plane side optical member 27 and the wafer W is filled with a first liquid such as pure water by operating a liquid supply device 37 during exposure of the wafer W. Thus, the exposure apparatus 11 of the present embodiment is of a liquid immersion type. The liquid supply device 37 will be described in detail later.

As shown in FIG. 1, the wafer stage 15 is arranged so that a mount surface on which the wafer W is mounted intersects with the optical path of the exposure light EL at the image plane side of the projection optical system 14. Further, the wafer stage 15 includes a holding unit 38 (for example, a vacuum chuck (not shown) that vacuum-attracts the wafer W) to hold the wafer W, a wafer holder (not shown) that holds the holding unit 38, and a Z leveling mechanism (not shown) that adjusts a Z axis position and inclination angles relative to the X axis and Y axis of the wafer holder. A wafer stage drive unit (not shown) moves the wafer stage 15 in the Y axis direction. That is, the wafer stage drive unit moves the wafer W, which is held on the holding unit 38, in the Y axis direction with a predetermined stroke. Further, the wafer stage drive unit also moves the wafer W, which is held on the holding unit 38, in the X-axis and Z axis directions.

When forming a circuit pattern of the reticle R in one shot region of the wafer W, the reticle stage drive unit moves the reticle R in the Y axis direction (for example, from the +Y direction side to the −Y direction side) for each predetermined stroke in a state in which an illumination region is formed on the reticle R by the illumination optical system 12. Further, the wafer stage drive unit moves the wafer W in the Y axis direction (for example, from the −Y direction side to the +Y direction side) at a speed ratio corresponding to the reduction rate of the projection optical system 14 in synchronism with the Y axis movement of the reticle R. Then, when the formation of the circuit pattern in the shot region ends, the circuit pattern formation is successively performed on another shot region of the wafer W.

The liquid supply device 37 of the present embodiment will now be described.

As shown in FIG. 1, the liquid supply device 37 includes a first liquid supply unit 41, which is driven to supply the predetermined void 36 with the first liquid (for example, pure water) that is used for exposure, and a second liquid supply unit 42, which is driven to supply the image plane side optical member 27 with a second liquid (for example, liquid containing an abrasive agent) that is used for polishing. Further, the liquid supply device 37 includes a liquid recovery unit 43, which is driven to recover the liquid from the predetermined void 36, and a switching unit 46, which is connected to supply tubes 44 and 45 respectively extending from the liquid supply units 41 and 42. The switching unit 46 is provided with a switching valve (not shown) including two input ports and one output port. The switching valve is driven to select the type of liquid supplied to a liquid supply/recovery member 47, which will be described later.

The liquid supply device 37 includes the liquid supply/recovery member 47, which is annular and supported by a support mechanism (not shown) so that the liquid supply/recovery member does not contact the image plane side optical member 27, the lens holder 28, and the wafer W. Further, the liquid supply/recovery member 47 is located at the −Z direction side of the flange 32 of the image plane side optical member 27 and surrounds the exposure light passage 29 of the image plane side optical member 27. That is, the liquid supply/recovery member 47 is arranged so that its inner side surface 47a faces a side surface 29a of the exposure light passage 29 of the image plane side optical member 27 and its +Z direction side surface 47b (upper surface as viewed in FIG. 2) faces a −Z direction side surface 32a of the flange 32 of the image plane side optical member 27. Further, the −Z direction side of the liquid supply/recovery member 47 is located further toward the −Z direction than the exit surface 30 of the image plane side optical member 27. In the present embodiment, the inner side surface 47a and +Z direction side surface 47b of the liquid supply/recovery member 47, the side surface 29a of the exposure light passage 29, and the −Z direction side surface 32a of the flange 32 are coated with fluorine resin or the like to repel water.

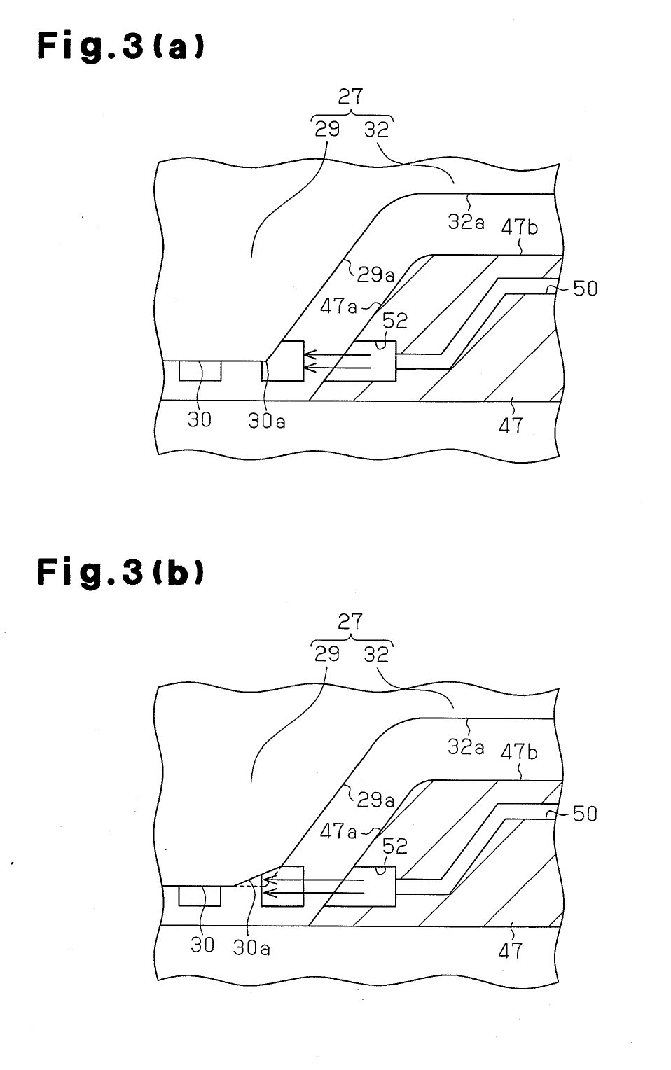

Further, the liquid supply/recovery member 47 is coupled to the switching unit 46 by a coupling tube 48 and to the liquid recovery unit 43 by a recovery tube 49. The liquid supply/recovery member 47 includes a liquid supply conduit 50, which is in communication with the coupling tube 48, and a liquid recovery conduit 51, which is in communication with the recovery tube 49. The inner side surface 47a of the liquid supply/recovery member 47 includes a plurality of supply nozzles 52, which are arranged around the exit surface 30 of the image plane side optical member 27 and the optical path of the exposure light EL at equal intervals in the circumferential direction. The liquid supply/recovery member 47 also includes a communication path (not shown) that communicates the supply nozzles 52 with the liquid supply conduit 50. Each supply nozzle 52 ejects a liquid (the first or second liquid), which is supplied through the liquid supply conduit 50, toward a peripheral portion 30a of the exit surface 30 of the image plane side optical member 27 (see FIG. 3(a)). Further, an annular recovery nozzle 53 is arranged in a −Z direction side of the liquid supply/recovery member 47. The recovery nozzle 53 extends around the optical path of the exposure light EL and is in communication with the liquid recovery conduit 51. A porous member 54, which includes a large number of pores, is arranged in the recovery nozzle 53.

In the present embodiment, the liquid supply device 37 includes a controller 55. The controller 55 includes a digital computer (not shown), which is formed by a CPU, a ROM, and a RAM, and driver circuits (not shown), which drive the liquid supply units 41 and 42, the liquid recovery unit 43, and the switching unit 46. During an exposure process, the controller 55 controls the first liquid supply unit 41 and the switching unit 46 to eject the first liquid from the supply nozzles 52 of the liquid supply/recovery member 47. In this case, the controller 55 controls the first liquid supply unit 41 to eject the first liquid from each supply nozzle 52 at a first flow velocity. Further, when replacing the wafer W that undergoes exposure, the controller 55 controls the liquid recovery unit 43 so that the liquid in the predetermined void 36 (that is, the first liquid) is recovered through the recovery nozzle 53 of the liquid supply/recovery member 47.

When the exposure apparatus 11 is used over a long period, the aberration of the projection optical system 14 may change over time due to changes in the properties of various optical members. An increase in the aberration of the projection optical system 14 may result in distortion of a circuit pattern formed on the wafer W. A typical exposure apparatus periodically adjusts aberration of the projection optical system 14 by moving the Z-axis positions of the optical members 18 to 23 in the projection optical system 14. However, the aberration of the projection optical system 14 cannot be sufficiently decreased just by moving the optical members 18 to 23. To solve this problem, in the present embodiment, the exit surface 30, which is an optical surface located at the image plane side of the image plane side optical member 27, is polished to deform the image plane side optical member 27 and adjust the aberration of the projection optical system 14.

In the present embodiment, the positions and orientations of the optical members 18 to 23 in the projection optical system 14 are changed to determine whether the aberration of the projection optical system 14 can be corrected. In this case, aberration of the projection optical system 14 can be measured using, for example, an aberration measurement device in a measurement stage as disclosed in US Patent Application Publication Nos. 2007/0201010, 2007/0263191, and 2008/0123067 or a wave-front aberration measurement device as disclosed in U.S. Pat. No. 6,914,665 to determine whether a residual component of the measured aberration is within a range of tolerance that can be corrected by changing the positions and orientations of the optical members 18 to 23. When the residual component is not in the range of tolerance, the exit surface 30, which is an image plane side optical surface of the image plane side optical member 27, is polished to deform the exit surface 30 and adjust the aberration of the projection optical system 14.

When polishing the image plane side optical member 27 in such a manner, the controller 55 controls the second liquid supply unit 42 and the switching unit 46 so that the second liquid is ejected from the supply nozzles 52 of the liquid supply/recovery member 47. The controller 55 also controls the liquid recovery unit 43 to recover liquid and sludge (hereinafter referred to as the polishing sludge), which is generated during polishing, from the predetermined void 36. In this case, the controller 55 controls the second liquid supply unit 42 so that the second liquid is ejected from the supply nozzles 52 at a second flow velocity, which is higher than the first flow velocity. Further, when polishing ends, the controller 55 controls the first liquid supply unit 41 and the switching unit 46 to eject the first liquid from the supply nozzles 52 of the liquid supply/recovery member 47 at the first flow velocity and controls the liquid recovery unit 43 to recover liquid and the like from the predetermined void 36. In the present embodiment, the liquid supply device 37 also functions as a polishing device that deforms the image plane side optical member 27.

At the first flow velocity, the first liquid cannot polish the image plane side optical member 27. The second flow velocity is extremely high and allows the second liquid to polish the image plane side optical member 27.

The operation of the exposure apparatus 11 for adjusting aberration of the projection optical system 14 will now be described with reference to FIG. 3. In FIG. 3(b), to facilitate illustration, a polishing amount (i.e., the removed amount) of the image plane side optical member 27 is shown in an exaggerated manner.

When adjusting aberration of the projection optical system 14, first, in order to move at least one of the optical members 18 to 23 in the lens barrel 17, the holding device 24 of at least one of the optical members is driven. For example, in order to move the optical member arranged in the vicinity of a position that is optically conjugate with the wafer W (image plane), the corresponding holding device 24 is driven. However, in some cases, aberration of the projection optical system 14 may not be adjusted within the range of tolerance just by adjusting the positions and orientations of the optical members 18 to 23.

To solve the problem, in the present embodiment, the image plane side optical member 27 is polished to change shape and thereby adjust the aberration of the projection optical system 14. Specifically, the switching unit 46 is driven to supply the second liquid to the liquid supply/recovery member 47, while the second liquid supply unit 42 is driven to eject the second liquid from the supply nozzles 52 of the liquid supply/recovery member 47. Accordingly, each supply nozzle 52 of the liquid supply/recovery member 47 ejects the second liquid at the second flow velocity toward the peripheral portion 30a of the exit surface 30 of the image plane side optical member 27 as shown in FIG. 3(a). The peripheral portion 30a includes a corner between the exit surface 30 of the image plane side optical member 27 and the side surface 29a of the exposure light passage 29. In the examples of FIGS. 3(a) and 3(b), in a state in which the supply nozzles 52 are arranged beside the peripheral portion 30a and located at the same height as the corner between the exit surface 30 and the side surface 29a, the supply nozzles 52 preferably eject the second liquid toward the peripheral portion 30a generally in the horizontal direction and inward in the radial direction generally at the same timing and the same ejection pressure. The supply nozzles 52 may eject the second liquid continuously over a controlled continuous time period or periodically eject the second liquid in the same pulse cycles.

An ejection pressure is applied by the second liquid ejected from the supply nozzles 52 to the peripheral portion 30a of the exit surface 30 of the image plane side optical member 27. As a result, the peripheral portion 30a of the exit surface 30 of the image plane side optical member 27 is polished by the second liquid. This deforms the exit surface 30 of the image plane side optical member 27, as shown in FIG. 3(b). Additionally, the second liquid is ejected from the supply nozzles 52, which are arranged at equal intervals in the circumferential direction. Thus, when the image plane side optical member 27 is polished, the image plane side optical member 27 is prevented from being moved in a direction orthogonal to the optical axis of the projection optical system 14. The peripheral portion 30a of the exit surface 30 of the image plane side optical member 27 is polished by approximately several tens of nanometers.

Further, the second liquid used to polish the image plane side optical member 27 is recovered by the recovery nozzle 53 by driving the liquid recovery unit 43. In this case, the recovery nozzle 53 also recovers the polishing sludge generated from the polishing of the image plane side optical member 27 with the second liquid.

When the polishing of the image plane side optical member 27 is completed, polishing sludge and polishing agent, which is contained in the second liquid, are collected on the image plane side optical member 27 and the wafer stage 15. Thus, upon completion of the polishing of the image plane side optical member 27, the second liquid supply unit 42 stops operating. At the same time, the switching unit 46 is driven to supply the first liquid to the liquid supply/recovery member 47. Further, the first liquid supply unit 41 is driven to eject the first liquid from the supply nozzles 52 of the liquid supply/recovery member 47. This cleans the image plane side optical member 27 and the wafer stage 15 with the first liquid. Then, after cleaning the image plane side optical member 27 and the wafer stage 15, the first liquid is recovered by the recovery nozzle 53 with the polishing agent and polishing sludge removed from the image plane side optical member 27 and the wafer stage 15. After such a cleaning process, which uses the first liquid, is performed for a predetermined period of time, the first liquid supply unit 41 and the liquid recovery unit 43 stop operating.

Subsequently, the projection optical system 14 is checked again for aberration. If the aberration is within the range of tolerance, the exposure process performed on the wafer W is restarted. If the aberration of the projection optical system 14 is still outside the range of tolerance, the image plane side optical member 27 is polished again with the second liquid. When polishing the image plane side optical member 27, preferably, a dummy wafer is arranged on the holding unit 38 of the wafer stage 15.

In the present embodiment, the nozzle described in Japanese Laid-Open Patent Publication No. 2005-246590 may be used as at least one ejection nozzle that ejects the polishing liquid (second liquid). Further, as described in Japanese Laid-Open Patent Publication No. 2005-246588, a polishing gas may be ejected from the ejection nozzle to polish the optical members.

Further, in the present embodiment, the shape of the polished exit surface 30 of the image plane side optical member 27 may be measured. Japanese Laid-Open Patent Publication No. 2002-372406 describes an example of such a surface shape measurement device. When measuring the shape of the polished exit surface 30 of the image plane side optical member 27, the shape of the exit surface 30 is first measured before polishing the exit surface 30 of the image plane side optical member 27. The exit surface 30 is polished based on information of the polishing amount required to adjust aberration of the projection optical system 14. Then, the shape of the exit surface 30 is re-measured again to determine whether the required shape has been obtained. If not, the exit surface 30 is polished again.

The present embodiment has the advantages described below.

(1) Aberration of the projection optical system 14 is adjusted by deforming the image plane side optical member 27, which is supported by the lens barrel 17, with the liquid supply device 37. Accordingly, in contrast with the prior art in which the optical members are removed from the projection optical system 14 to have there shapes changed, the optical members do not have to be removed from the projection optical system 14. This allows the aberration of the projection optical system 14 to be easily adjusted within a short period of time, reduces the non-operated time of the exposure apparatus 11, and improves productivity.

(2) In the present embodiment, among the optical members 18 to 23 and 27 supported by the lens barrel 17, the exit surface 30 of the image plane side optical member 27, which is located closest to the image plane side, is polished. This prevents polishing sludge, which is generated during polishing, from entering the lens barrel 17. When polishing an optical member other than the image plane side optical member 27, polishing sludge may enter the lens barrel 17. If the polishing sludge enters the lens barrel 17, it cannot easily be removed. In the present embodiment, the polishing sludge subtly enters the lens barrel 17. Thus, the polishing sludge generated during polishing of the image plane side optical member 27 is easily recovered. Further, the polishing sludge is prevented from remaining in the optical path of the exposure light EL. This prevents distortion in a circuit pattern formed on the wafer W that would be caused by residual polishing sludge in a subsequent exposure process.

(3) The liquid supply device 37, which supplies the first liquid to the predetermined void 36 during an exposure process, functions also as a polishing device that polishes the image plane side optical member 27. Thus, the number of components is prevented from being increased as when a polishing device is separately provided from the liquid supply device 37.

(4) The liquid supply device 37 switches the supplied liquid from the first liquid to the second liquid, which is used for polishing. Thus, the image plane side optical member 27 is polished more effectively than when polishing the image plane side optical member 27 with the first liquid.

(5) The liquid recovery unit 43 uses the recovery nozzle 53 to recover polishing sludge, which is generated when polishing the image plane side optical member 27, together with the first liquid that is supplied as a cleaning liquid. This prevents exposure failures that would be caused by residual polishing sludge remaining in the optical path of the exposure light EL.

(6) Further, in the present embodiment, the flow velocity of the second liquid when supplied to polish the image plane side optical member 27 is set to the second flow velocity, which is higher than the first flow velocity set when the first liquid is supplied during an exposure process. This prevents the image plane side optical member 27 from being polished by the ejection pressure applied by the first liquid to the image plane side optical member 27 when the first liquid is being supplied.

(7) In the present embodiment, the supply nozzles 52, which are arranged at equal intervals in the circumferential direction, eject the second liquid and apply an ejection pressure to the peripheral portion 30a in the exit surface 30 of the image plane side optical member 27. This polishes the peripheral portion 30a. In this case, ejection pressure directed inward in the radial direction is applied to the exit surface 30 at equal intervals in the circumferential direction. This prevents the image plane side optical member 27 from being moved by the ejection pressure applied to the image plane side optical member 27 when being polished.

(8) When adjusting aberration of the projection optical system 14, in addition to the positions and orientations of the optical members 18 to 23, the image plane side optical member 27 is deformed. Thus, the aberration of the projection optical system 14 is adjusted with further accuracy than the prior art. Accordingly, a circuit pattern having an appropriate shape can be formed on the wafer W.

(9) An antireflective coating does not have to be applied to the exit surface 30 of the image plane side optical member 27 in the liquid immersion projection optical system of the present embodiment because of the small difference in refractive index between the image plane side optical member 27 and the first liquid. This eliminates the task for applying the antireflective coating again to the exit surface 30 after the exit surface 30 is polished by the polishing device.

It should be apparent to those skilled in the art that the present invention may be embodied in many other specific forms without departing from the spirit or scope of the invention. Particularly, it should be understood that the present invention may be embodied in the following forms.

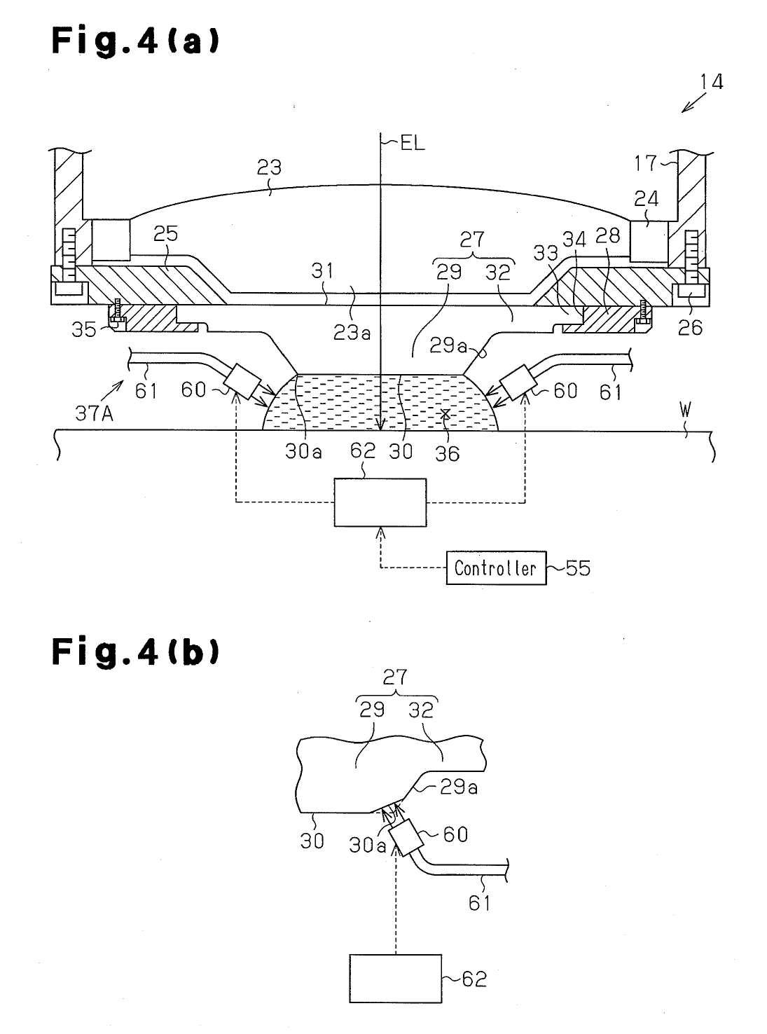

In one embodiment, a liquid supply device may be able to eject liquid in directions that differ between an exposure processing and a polishing process. For example, as shown in FIGS. 4(a) and 4(b), a liquid supply device 37A includes a plurality of supply nozzles 60 (only two are shown in FIG. 4(a)), which are arranged around the exposure light passage 29 the image plane side optical member 27, and liquid supply conduits 61, which supply the first or second liquid to each supply nozzle 60. Further, the liquid supply device 37A includes a moving unit 62, which moves each supply nozzle 60 between a first position (position shown in FIG. 3(a)), at which liquid is supplied toward a wafer stage 15, and a second position (position shown in FIG. 3(b)), at which the liquid is supplied toward the peripheral portion 30a in the exit surface 30 of the image plane side optical member 27. In this structure, during an exposure process, the moving unit 62 is driven to arrange each supply nozzle 60 at the first position. Then, the first liquid is ejected from each supply nozzles 60. This fills the predetermined void 36 with the first liquid.

During a polishing process, the moving unit 62 is driven to arrange each supply nozzle 60 at the second position. Then, the second liquid (polishing liquid) is ejected from the supply nozzles 60. As a result, the peripheral portion 30a of the exit surface 30 of the image plane side optical member 27 is polished by the ejection pressure of the second liquid. In FIGS. 4(a) and 4(b), the recovery unit for recovering the liquid is not shown. Further, in FIG. 4(b), to facilitate illustration, a polishing amount of the image plane side optical member 27 (that is, an amount of polished element) is shown in an exaggerated manner.

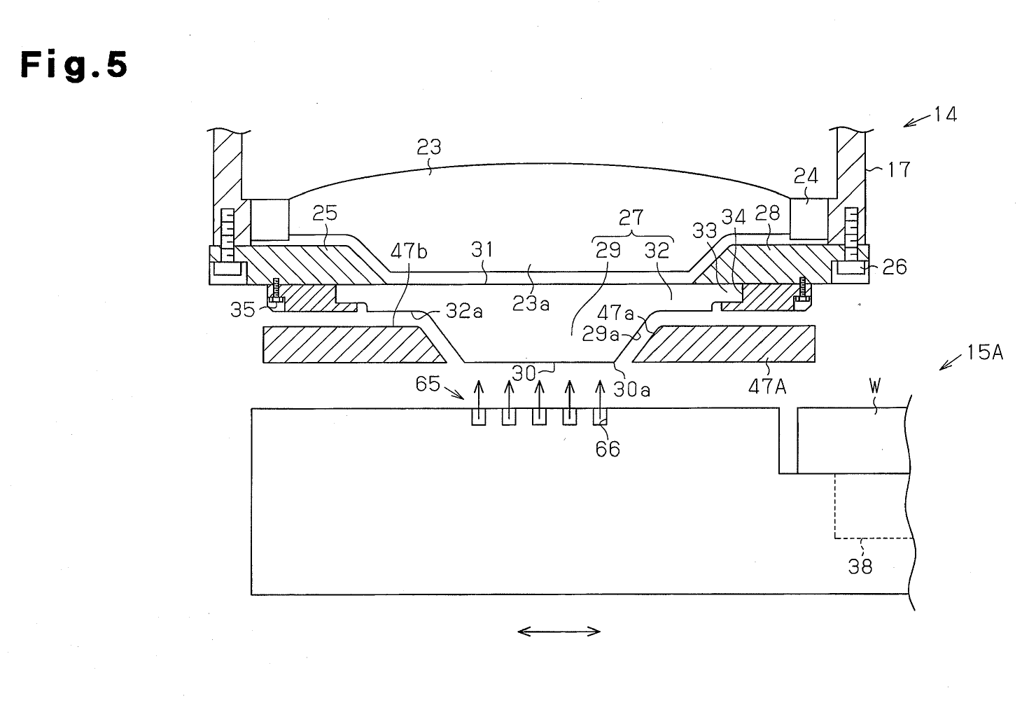

In one embodiment, a polishing device for polishing the optical members may be provided separately from the liquid supply device 37. For example, as shown in FIG. 5, a polishing device 65 may be arranged on a wafer stage 15A at one side (left side as viewed in FIG. 5) of the portion at which the wafer W is mounted. More specifically, beside the portion at which the wafer W is mounted on the wafer stage 15A, a plurality of ejection nozzles 66 (only five are shown in FIG. 5) are arranged to eject polishing liquid in the +Z direction. When polishing the image plane side optical member 27, the wafer stage 15A is moved to arrange the ejection nozzles 66 directly under the image plane side optical member 27. In this state, the polishing liquid is ejected from the ejection nozzles 66. As a result, the exit surface 30 of the image plane side optical member 27 is polished to adjust the aberration of the projection optical system 14. In FIG. 5, the supply nozzles 52 and the recovery nozzle 53 of a liquid supply/recovery member 47A are not shown. Further, in the liquid supply/recovery member 47A, the supply nozzles 52 may be arranged on the wafer stage 15A to eject liquid. The ejection nozzles 66 may be configured to be capable of varying the direction in which polishing liquid is ejected. The ejection nozzles 66 may eject polishing liquid at generally the same ejection pressure at generally the same time. Alternatively, at least only one of the ejection nozzles 66 located at a selected position corresponding to measured aberration of a projection optical system 14 may eject the polishing liquid under an ejection pressure controlled in accordance with the measured aberration of the projection optical system 14.

In one embodiment, the first liquid may be used also when polishing the peripheral portion 30a of the exit surface 30 of the image plane side optical member 27. In such a case, the first liquid is ejected from the supply nozzles 52 at a second flow velocity to polish the peripheral portion 30a in the exit surface 30 of the image plane side optical member 27. When the second liquid is not used for polishing, the switching unit 46 and second liquid supply unit 42 may be eliminated.

In this case, during polishing, the second liquid may be used when the polishing amount of the image plane side optical member 27 (i.e., the polished amount of the peripheral portion 30a in the exit surface 30) is large, and the first liquid may be used when the polishing amount is small.

In one embodiment, the liquid supply device 37 may be formed so that the ejected amount of the liquid from each supply nozzles 52 is fixed. In this case, the flow velocity of the liquid ejected from each supply nozzle 52 is preferably set so that the image plane side optical member 27 cannot be polished by the first liquid.

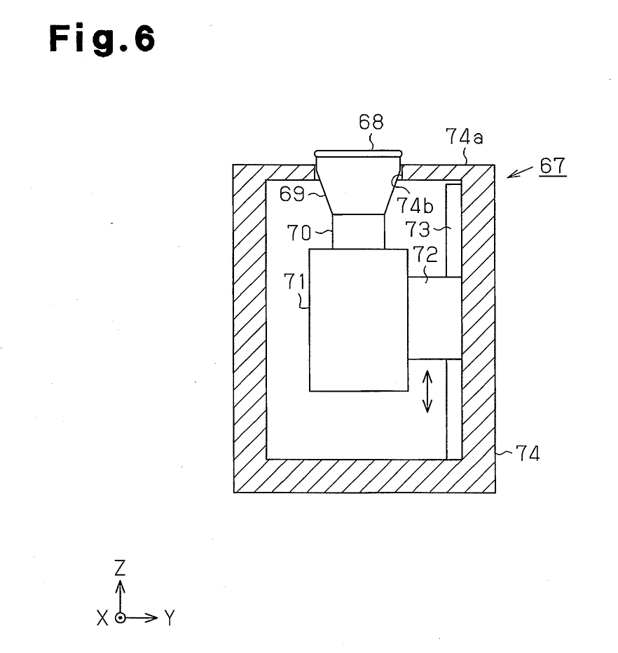

In one embodiment, the polishing device may include a polishing member that polishes the optical members by directly contacting the optical members. For example, as shown in FIG. 6, a polishing device 67 may include a polishing pad 68 that comes into contact with the exit surface 30 of the image plane side optical member 27. More specifically, in the polishing device 67, the polishing pad 68 is held on one end of a rotary shaft 70 by a holding unit 69 and rotates about an axis extending the Z axis. A motor 71 is arranged at the opposite side of the rotary shaft 70. A support unit 72 supports the motor 71 to be movable in the Z axis direction along a rail 73 extending in the Z axis direction. The rail 73 is fixed to a case 74 of the polishing device 67. The case 74 includes an upper wall 74a through which an opening 74b extends to permit passage of the polishing pad 68 and the holding unit 69. The upper wall 74a of the case 74 is larger than the exit surface 30 of the image plane side optical member 27. The upper wall 74a of the case 74 may be larger than a liquid immersion region (i.e., region of the wafer W occupied by the first liquid in the predetermined void 36).

The operation of the polishing device 67 will now be briefly described. When polishing the image plane side optical member 27, the polishing device 67 rotates the polishing pad 68 and moves the polishing pad 68 in the Z axis direction to contact the exit surface 30 of the image plane side optical member 27. In this state, the polishing device 67 is moved in the XY directions by a drive device (not shown). That is, the polishing pad 68 moves along the exit surface 30 of the image plane side optical member 27 in the XY directions. In this case, the polishing amount of the image plane side optical member 27 at the exit surface 30 is determined by the contact pressure between the exit surface 30 and polishing pad 68 and the time of contact with the polishing pad 68.

In one embodiment, the exposure apparatus 11 may include a polishing device that polishes an optical member other than the image plane side optical member 27 among the optical members 18 to 23 and 27 of the projection optical system 14. In this case, a recovery mechanism may be used to recover polishing sludge generated when polishing the other optical member.

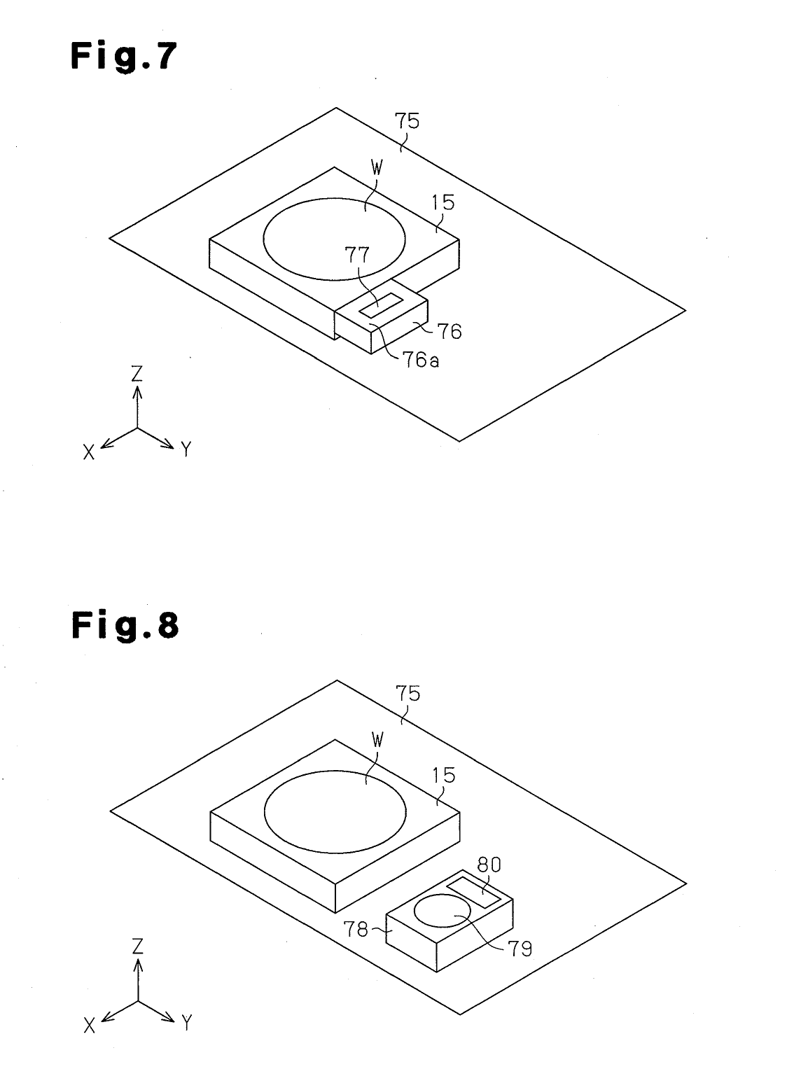

In one embodiment, the polishing device that polishes a optical members may be attachable to the wafer stage 15. For example, as shown in FIG. 7, a polishing device 76 can be attached beside the wafer stage 15. The polishing device 76 includes an upper surface (+Z direction surface) 76a and a polishing unit 77, arranged on the upper surface 76a. The polishing unit 77 may include at least one ejection nozzle that ejects a polishing medium (liquid or gas) or be a polishing member that directly contacts an optical member to polish the optical member. In such a structure, the upper surface 76a of the polishing unit 77 is generally flush with the surface of the wafer W. Further, the size of the upper surface 76a is set to include the liquid immersion region. The portion of the exit surface 30 of the image plane side optical member 27 polished by the polishing device 76 may be specified by an interferometer that measures the position of the wafer stage 15 in an XY plane. The portion polished by the polishing device 76 is managed using the same coordinates as the wafer stage 15, which is moved on a table 75 in the XY direction. The polishing device 76 may be attached to and detached from the wafer stage 15 automatically by an attaching/detaching device or manually by an operator.

In one embodiment, a polishing device that polishes an optical member may be mounted on a measurement stage 78 that includes a measurement device, which measures the imaging characteristics of the projection optical system 14 and is arranged independently from the wafer stage 15 that holds a wafer W. For example, as shown in FIG. 8, a polishing device 80 may be arranged on part of a measurement stage 78, which includes a measurement device 79. In this case, the polishing device 80 may include at least one ejection nozzle that ejects a polishing medium (liquid or gas) or be a polishing member that directly contacts an optical member to polish the optical member. The wafer stage 15 and the measurement stage 78 are movable on a table 75 in the XY directions and have XY coordinates managed by an interferometer (not shown). US Patent Application Publication No. 2008/0123067 describes one example of the measurement stage 78.

In one embodiment, the exposure apparatus may include a polishing device that polishes the optical member of an illumination optical system 12.

In one embodiment, in addition to manufacturing micro-devices such as semiconductor elements, the exposure apparatus 11 may transfer circuit patterns from a mother reticle to a glass substrate or a silicon wafer in order to manufacture reticles or masks used in a light exposure apparatus, an EUV exposure apparatus, an X-ray exposure apparatus, and electron-beam exposure apparatus. Further, the exposure apparatus 11 may be used to transfer a device pattern onto a glass plate and manufacture a display such as a liquid crystal display (LCD), transfer a device pattern onto a ceramic wafer to manufacture a thin-film magnetic head or the like, or manufacture an imaging device such as a CCD.

In one embodiment, the light source device may be capable of supplying, for example, g-line (436 nm), i-line (365 nm), KrF excimer laser (248 nm), F₂ laser (157 nm), Kr₂ laser (146 nm), Ar₂ laser (126 nm), or the like. Further, the light source device may be capable of supplying harmonics obtained by amplifying mono-wavelength laser light in the infrared or visible range, which is oscillated by a DFB semiconductor laser or fiber laser, with a fiber amplifier doped with, for example, erbium (or both erbium and ytterbium) and wavelength-converted to ultraviolet light with a nonlinear optical crystal.

In one embodiment, the first liquid supplied to the predetermined void 36 may be a liquid other than pure water as long as it has a refractive index that is greater than 1.1. The predetermined void 36 may be filled with the first liquid using any one of various techniques. International Patent Publication No. WO99/49504 describes a technique for locally filling a liquid. Japanese Laid-Open Patent Publication No. 6-124873 describes a technique for moving a stage, which holds a substrate that is subject to exposure, in a liquid bath. Japanese Laid-Open Patent Publication No. 10-303114 describes a technique for forming a liquid bath of a predetermined depth on a stage and holding the substrate in the bath.

In one embodiment, a polarized illumination method may be applied. US Patent Application Publication No. 2006/0203214, US Patent Application Publication No. 2006/0170901, and US Patent Application Publication No. 2007/0146676 describe such a polarized illumination method.

In one embodiment, the exposure apparatus 11 may be of a step-and-repeat type.

In one embodiment, the exposure apparatus may be of a mask-less type in which a variable pattern generator (e.g., digital mirror device or digital micro-mirror device (DMD)) is used. Such mask-less exposure apparatus is disclosed in, for example, Japanese Laid-Open Patent Publication No. 2004-304135, International Patent Publication No. 2006/080285 pamphlet, and the corresponding US Patent Application Publication No. 2007/0296936.

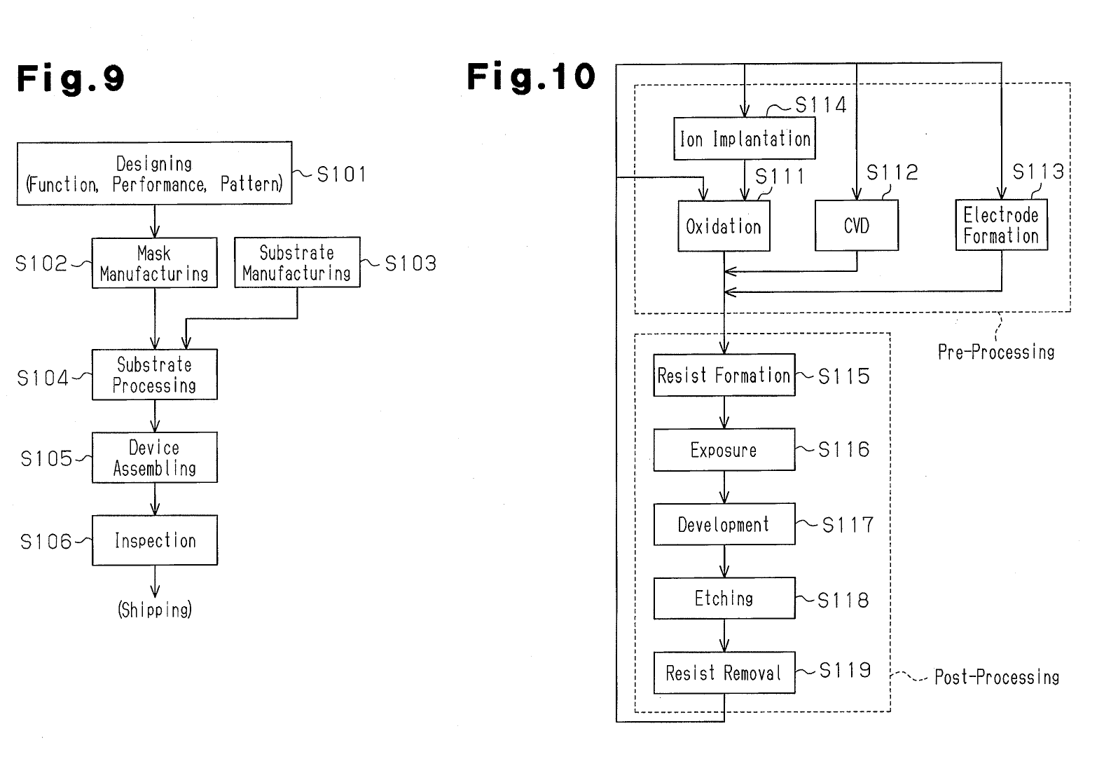

A method for manufacturing a device with the exposure apparatus 11 according to the present invention embodied in a micro-device manufacturing method used in a lithography process will now be described. FIG. 9 is a flowchart showing a manufacturing example of a micro-device (semiconductor chip such as IC or LSI, liquid crystal panel, CCD, thin-film magnetic head, micro-machine, or the like).

First, in block S101 (design step), function and performance designing of a micro-device is performed (for example, semiconductor device circuit design) and pattern designing for realizing the functions is performed. Subsequently, in block S102 (mask manufacturing step), a mask (reticle R or the like) including the designed circuit pattern is formed. In block S103 (substrate manufacturing step), silicon, glass, or ceramic is used to manufacture a substrate (wafer W when a silicon material is used).

Next, in block S104 (substrate processing step), the mask and the substrate prepared in blocks S101 to S104 are used to form actual circuits on the substrate using a lithographic technique, as will be described later. Subsequently, in block S105 (device assembling step), the substrate processed in block S104 is used to assemble a device. Step S105 includes a dicing process, a bonding process, and a packaging process (chip encapsulation). Finally, in block S106 (inspection step), the micro-device manufactured in block S105 undergoes inspections such as operation test and a durability test. After these steps are performed, the micro-device is completed and shipped out of the factory.

FIG. 10 is a chart showing one example of detailed processes of block S104 in the case of a semiconductor device.

In block S111 (oxidation step), a surface of the substrate is oxidized. In block S112 (CVD step), an insulation film is formed on the surface of the substrate. In block S113 (electrode formation step), an electrode is formed on the substrate through vapor deposition. In block S114 (ion implantation step), ions are implanted in the substrate. Each of blocks S111 to S114 serves as a pre-processing step for each substrate processing stage and are selected and performed in each stage as required.

In each substrate processing stage, when the pre-processing step ends, post-processing is performed as will now be described. In the post-processing, first, in block S115 (resist formation step), a photosensitive material is applied to the substrate. Subsequently, in block S116 (exposure step), a circuit pattern of a mask is transferred to the substrate using the above-described lithography system (exposure apparatus 11). Next, in block S117 (development step), the substrate exposed in block S116 is developed to form a mask layer including the circuit pattern on the surface of the substrate. Further, in block S118 (etching step), exposed members are etched and removed except for portions including residual resist. Then, in block S119 (resist removal step), the photosensitive material that has become unnecessary after the etching is removed. In this manner, the surface of the substrate is processed with the mask layer in blocks S118 and S119. The pre-processing and post-processing are repeated to form multiple circuit patterns on the substrate.

The present examples and embodiments are to be considered as illustrative and not restrictive, and the invention is not to be limited to the details given herein, but may be modified within the scope and equivalence of the appended claims.

### DESCRIPTION OF REFERENCE CHARACTERS

11: exposure apparatus
12: illumination optical system
14: projection optical system
15, 15A: wafer stage serving as a holding device
17: lens barrel serving as a support member
18 to 23: optical member, which serves as a movable optical member, and further optical member
24: holding device serving as an optical member holding device
27: image plane side optical member
30: exit surface serving as an image plane side optical surface
36: predetermined void
37, 37A: liquid supply device serving as a polishing device
38: holding unit
43: liquid recovery unit forming recovery unit
46: switching unit
52, 60: supply nozzle
53: recovery nozzle forming a recovery unit
62: moving unit
65, 67, 76, 80: polishing device
66: ejection nozzle
68: polishing pad
77: polishing unit
EL: exposure light
W: wafer serving as a substrate

1. An exposure apparatus that illuminates a predetermined pattern with light and irradiates a substrate, to which a photosensitive material is applied, with the light that passes through the predetermined pattern, the exposure apparatus comprising:
an optical system including an optical member, which is arranged in an optical path of the light, and a support member, which supports the optical member; and
a polishing device that polishes the optical member in a state supported by the support member to change shape of the optical member.

2. The exposure apparatus according to claim 1, wherein
the optical system includes a plurality of the optical members, and
the polishing device polishes an image plane side optical surface of an image plane side optical member, which is one of the optical members that is located closest to an image plane.

3. The exposure apparatus according to claim 2, wherein the optical system is a projection optical system that guides the light that passes through the predetermined pattern to the substrate, and wherein the exposure apparatus further comprises:
a holding device including a holding unit, which holds the substrate; and
a liquid supply device that hermetically seals a void formed between the image plane side optical member and the holding unit, wherein the liquid supply device includes a supply nozzle capable of ejecting liquid, through which the light is passable, toward the optical member, and the liquid supply device functions as the polishing device.

4. The exposure apparatus according to claim 3, wherein the liquid supply device further includes a recovery unit that recovers the liquid ejected from the supply nozzle.

5. The exposure apparatus according to claim 3, wherein the liquid supply device is capable of adjusting the amount of the liquid ejected per unit time from the supply nozzle.

6. The exposure apparatus according to claim 3, wherein the liquid supply device further includes a moving unit that moves the supply nozzle to change the direction in which the liquid is ejected.

7. The exposure apparatus according to claim 3, wherein the liquid supply device further includes a switching unit that switches the liquid ejected from the supply nozzle between the liquid through which the light is passable, which is a first liquid, and a second liquid, which differs from the first liquid.

8. The exposure apparatus according to claim 1, wherein the polishing device includes an ejection nozzle that ejects polishing liquid toward the optical member.

9. The exposure apparatus according to claim 8, wherein
the optical system is a projection optical system that guides the light that passes through the predetermined pattern to the substrate,
the optical system further includes a holding device,
the holding device includes a holding unit that holds the substrate, and
the ejection nozzle ejects the polishing liquid toward the optical member from the holding device.

10. The exposure apparatus according to claim 1, wherein the polishing device includes a plurality of supply nozzles, which are arranged beside a peripheral portion of an optical surface of the optical member, wherein the supply nozzles eject polishing liquid toward the peripheral portion generally at the same time with generally the same ejection pressure.

11. The exposure apparatus according to claim 1, wherein the polishing device includes a plurality of supply nozzles that face an optical surface of the optical member and eject polishing liquid toward the optical surface at a controlled timing and a controlled ejection pressure.

12. The exposure apparatus according to claim 10, wherein the polishing device includes a controller that controls ejection of the polishing liquid from the supply nozzles.

13. The exposure apparatus according to claim 2, wherein the optical system further includes an optical member holding device that holds a further optical member, which differs from the image plane side optical member, and is capable of moving the further optical member relative to the support member.

14. The exposure apparatus according to claim 2, wherein
the optical system is a projection optical system that guides the light that passes through the predetermined pattern to the substrate, and
the optical system further includes:
a holding device including a holding unit that holds the substrate; and
a liquid supply device that hermetically seals a void formed between the image plane side optical member and the holding unit.

15. The exposure apparatus according to claim 2, wherein the image plane side optical surface of the image plane side optical member is uncoated.

16. A method for manufacturing a device, the method comprising:
exposing a pattern image, with the exposure apparatus according to claim 1, based on the predetermined pattern on a surface of the substrate;
developing the exposed substrate to form a mask layer having a shape corresponding to the pattern image on the surface of the substrate; and
processing the surface of the substrate through the mask layer formed on the surface of the substrate.

17. A polishing device arranged on an exposure apparatus that illuminates a predetermined pattern with light and irradiates a substrate, to which a photosensitive material is applied, with the light that passes through the predetermined pattern, the exposure apparatus is provided with an optical system including an optical member, which is arranged in an optical path of the light, and a support member, which supports the optical member, and wherein the polishing device polishes the optical member in a state supported by the support member to change shape of the optical member.

18. The polishing device according to claim 17, wherein
the optical system includes a plurality of the optical members, and
the polishing device polishes an image plane side optical surface of an image plane side optical member, which is one of the optical members that is located closest to an image plane.

19. The polishing device according to claim 17, wherein
the optical system is a projection optical system that guides the light that passes through the predetermined pattern to the substrate and includes a plurality of the optical members, and the exposure apparatus further includes:
a holding device including a holding unit, which holds the substrate; and
a liquid supply device that hermetically seals a void formed between an image plane side optical member, which is one of the optical members that is located closest to an image plane, and the holding unit.

20. The polishing device according to claim 19, further comprising a supply nozzle capable of ejecting a medium toward an image plane side optical surface of the image plane side optical member.

21. The polishing device according to claim 20, further including a recovery unit that recovers the medium ejected from the supply nozzle.

22. The polishing device according to claim 20, wherein the amount of the liquid ejected per unit time from the supply nozzle is adjustable.

23. The polishing device according to claim 20, further comprising a moving unit that moves the supply nozzle to change the direction in which the medium is ejected.

24. The polishing device according to claim 19, further comprising a polishing pad that is adapted to contact the image plane side optical surface of the image plane side optical member.

25. The polishing device according to claim 18, wherein the image plane side optical surface of the image plane side optical member is uncoated.

26. An exposure apparatus comprising the polishing device according to claim 17.

27. A method for manufacturing a device, the method comprising:
exposing a pattern image, with the exposure apparatus according to claim 26, based on the predetermined pattern on a surface of the substrate;
developing the exposed substrate to form a mask layer having a shape corresponding to the pattern image on the surface of the substrate; and
processing the surface of the substrate through the mask layer formed on the surface of the substrate.

28. A method for polishing an optical member of an exposure apparatus, wherein the exposure apparatus illuminates a predetermined pattern with light and irradiates a substrate, to which a photosensitive material is applied, with the light passing through the predetermined pattern, wherein the exposure apparatus is provided with an optical system including the optical member, which is arranged in an optical path of the light, and a support member, which supports the optical member, wherein the method comprises polishing the optical member in a state supported by the support member to change shape of the optical member.

29. The method according to claim 28, wherein the optical system includes a plurality of the optical members, and the method further comprises polishing an image plane side optical surface of an image plane side optical member, which is one of the optical members that is located closest to an image plane.

30. The method according to claim 28, wherein
the optical system is a projection optical system that guides the light that passes through the predetermined pattern to the substrate and includes a plurality of the optical members; and
the exposure apparatus further includes
a holding device including a holding unit that holds the substrate, and
a liquid supply device that hermetically seals a void formed between an image plane side optical member, which is the one of the optical members that is located closest to an image plane, and the holding unit.

31. The method according to claim 29, further comprising ejecting the medium toward the image plane side optical surface of the image plane side optical member.

32. The method according to claim 31, further comprising recovering the ejected medium.

33. The method according to claim 31, further comprising adjusting the amount of the medium ejected per unit time.

34. The method according to claim 31, further comprising changing the direction in which the medium is ejected.

35. The method according to claim 28, wherein the optical system includes a plurality of the optical members, the method further comprising polishing an image plane side optical surface of an image plane side optical member, which is one of the optical members that is located closest to an image plane, with a polishing pad.

36. The method according to claim 28, wherein
the optical system includes a plurality of the optical members, and
an image plane side optical surface of an image plane side optical member, which is one of the optical members that is located closest to an image plane, is uncoated.

37. The method according to claim 28, further comprising:
measuring a surface shape of the optical member; and
changing shape of the optical member based on a result of the measurement.

38. The method according to claim 28, wherein
the optical system is a projection optical system that guides the light that passes through the predetermined pattern to the substrate,
the optical system further includes a movable optical member arranged in the optical path of the light so that its position is adjustable to adjust aberration of the projection optical system, and
the method further comprises determining whether or not aberration of the projection optical system is in a predetermined range in which the movable optical member is capable of adjusting the aberration.

39. The method according to claim 38, further comprising polishing the optical member in a state supported by the support member to change shape of the optical member when it is determined that the aberration is outside the predetermined range.

40. A method for manufacturing a device using an exposure apparatus that illuminates a predetermined pattern with light and irradiates a substrate, to which a photosensitive material is applied, with the light that passes through the predetermined pattern, the exposure apparatus is provided with an optical system including an optical member, which is arranged in an optical path of the light, and a support member, which supports the optical member, and wherein the method comprises:
exposing a pattern image based on the predetermined pattern on a surface of the substrate;
developing the exposed substrate to form a mask layer having a shape corresponding to the pattern image on the surface of the substrate;
processing the surface of the substrate through the mask layer formed on the surface of the substrate; and
polishing the optical member in a state supported by the support member to change shape of the optical member using the method according to claim 28 at a time that differs from a time when the surface of the substrate is exposed.
